(19) United States
(12) Patent Application Publication
(10) Pub. No.: US 2009/0038114 A1
(43) Pub. Date: Feb. 12, 2009

(54) Microphone Handle Grip Structure

(76) Inventor: Ching-Wen Chen, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/834,992

(22) Filed: Aug. 7, 2007

(51) Int. Cl. H01R 13/66

(52) U.S. Cl. 16/110.1

(57) ABSTRACT

A microphone handle grip structure includes a handle, a grip and at least one press fixing member. The handle has a receiving space and a slot, wherein a distance between the slot and an outer edge of the handle is defined by a height. The grip is rested on the outer edge of the handle closely and has two opposite sides located on the two oblique side faces of the slot respectively. The press fixing member has a shape substantially matching that of the slot and is pressed into the slot to press the two opposite sides of the grip so that the two opposite sides of the grip are rested on the two oblique side faces of the slot respectively, and the press fixing member and the grip are fixed on the slot of the handle.

### BACKGROUND OF THE INVENTION

1. Field of the Invention

The present invention relates to a microphone handle and, more particularly, to a microphone handle grip structure.

2. Description of the Related Art

A conventional microphone has a housing made of metal to reduce interference of the electromagnetic waves. However, the microphone is not grounded properly so that when a user's hand contacts the metallic housing of the microphone, a static electricity is produced between the user's hand and the metallic housing of the microphone due to friction, thereby easily producing noise. In addition, the metallic housing of the microphone has a fixed shape without variation, thereby decreasing the outer appearance of the microphone.

### BRIEF SUMMARY OF THE INVENTION

In accordance with the present invention, there is provided a microphone handle grip structure, comprising a handle which is a hollow body having a receiving space, the handle having a slot, the slot of the handle having two oblique side faces, wherein a distance between the slot of the handle and an outer edge of the handle is defined by a height; a grip rested on the outer edge of the handle closely, the grip having two opposite sides located on the two oblique side faces of the slot of the handle respectively; and at least one press fixing member having a shape substantially matching that of the slot of the handle, wherein the press fixing member is pressed into the slot of the handle to press the two opposite sides of the grip so that the two opposite sides of the grip are rested on the two oblique side faces of the slot of the handle respectively, and the press fixing member and the grip are fixed on the slot of the handle.

The primary objective of the present invention is to provide a microphone handle grip structure, wherein the grip is fixed on the handle by a close fit between the press fixing member, the grip and the slot of the handle so that the grip is mounted on the handle easily and quickly.

Another objective of the present invention is to provide a microphone handle grip structure, wherein the grip has an outside provided with a determined pattern to enhance the aesthetic quality of the microphone handle grip structure.

A further objective of the present invention is to provide a microphone handle grip structure, wherein the handle is made of metal to r educe interference of the electromagnetic waves.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a microphone handle grip structure in accordance with the preferred embodiment of the present invention.

FIG. 2 is an exploded perspective view of the microphone handle grip structure as shown in FIG. 1.

FIG. 3 is a cross-sectional view of the microphone handle grip structure taken along line 3-3 as shown in FIG. 1.

### DETAILED DESCRIPTION OF THE INVENTION

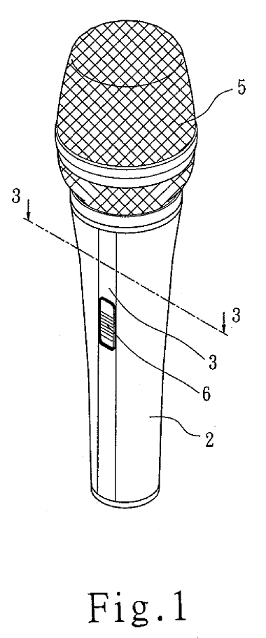

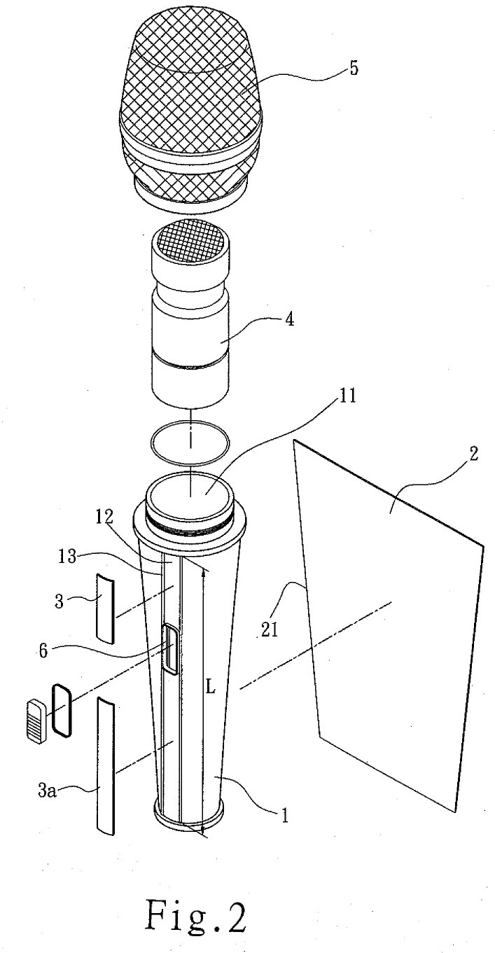

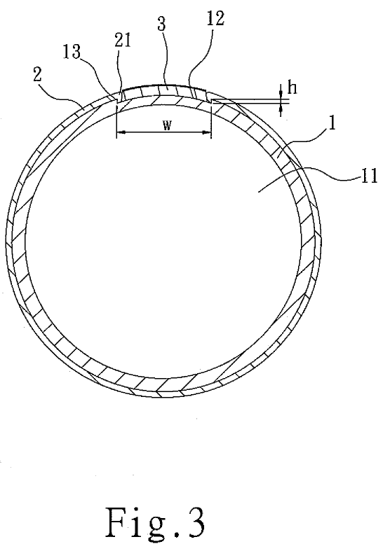

Referring to FIGS. 1-3, a microphone handle grip structure in accordance with the preferred embodiment of the present invention comprises a handle 1, a grip 2 and at least one press fixing member 3.

The handle 1 is a hollow body having a receiving space 11 to receive a sound chamber 4. A head 5 is locked onto the receiving space 11 of the handle 1 to seal the sound chamber 4 in the receiving space 11 of the handle 1. The handle 1 is made of metal to reduce interference of the electromagnetic waves. In the preferred embodiment of the present invention, the handle 1 is further provided with a slot 12. A distance between the slot 12 of the handle 1 and an outer edge of the handle 1 is defined by a height “h”. The slot 12 of the handle 1 has two oblique side faces 13. Each of the two oblique side faces 13 of the slot 12 of the handle 1 has a length “L”, and a distance between the two oblique side faces 13 of the slot 12 of the handle 1 is defined by a width “W”.

The grip 2 has a length substantially equal to the length “L” of each of the two oblique side faces 13 of the slot 12 of the handle 1. The grip 2 is rested on the outer edge of the handle 1 closely. Thus, the grip 2 has a substantially trapezium profile. The grip 2 has two opposite sides 21 located on the two oblique side faces 13 of the slot 12 of the handle 1 respectively. In the preferred embodiment of the present invention, the grip 2 is made of natural leather or artificial leather. The grip 2 has an outside provided with a determined pattern (not shown). Preferably, the pattern is a wooden vein pattern. Preferably, the pattern is located on the outside of the grip by bonding or stitching.

The press fixing member 3 has a shape substantially matching that of the slot 12 of the handle 1. In the preferred embodiment of the present invention, the microphone handle grip structure comprises two press fixing members 3 and 3a located at two sides of a control portion 6 of the handle 1 respectively. The two press fixing members 3 and 3a have different lengths and the same shape to correspond to the slot 12 of the handle 1. Thus, only the press fixing member 3 is described in detail. The press fixing member 3 is pressed into the slot 12 of the handle 1 to press the two opposite sides 21 of the grip 2 so that the two opposite sides 21 of the grip 2 are rested on the two oblique side faces 13 of the slot 12 of the handle 1 respectively, and the press fixing member 3 and the grip 2 are fixed on the slot 12 of the handle 1.

Accordingly, the grip 2 is fixed on the handle 1 by a close fit between the press fixing member 3, the grip 2 and the slot 12 of the handle 1 so that the grip 2 is mounted on the handle 1 easily and quickly. In addition, the grip 2 has an outside provided with a determined pattern to enhance the aesthetic quality of the microphone handle grip structure. Further, the handle 1 is made of metal to reduce interference of the electromagnetic waves.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A microphone handle grip structure, comprising:
a handle which is a hollow body having a receiving space, the handle having a slot, the slot of the handle having two oblique side faces, wherein a distance between the slot of the handle and an outer edge of the handle is defined by a height;
a grip rested on the outer edge of the handle closely, the grip having two opposite sides located on the two oblique side faces of the slot of the handle respectively;
at least one press fixing member having a shape substantially matching that of the slot of the handle, wherein the press fixing member is pressed into the slot of the handle to press the two opposite sides of the grip so that the two opposite sides of the grip are rested on the two oblique side faces of the slot of the handle respectively, and the press fixing member and the grip are fixed on the slot of the handle.

2. The microphone handle grip structure in accordance with claim 1, wherein a distance between the two oblique side faces of the slot of the handle is defined by a width.

3. The microphone handle grip structure in accordance with claim 1, wherein the grip has an outside provided with a pattern.

4. The microphone handle grip structure in accordance with claim 3, wherein the pattern is located on the outside of the grip by bonding.

5. The microphone handle grip structure in accordance with claim 3, wherein the pattern is located on the outside of the grip by stitching.

6. The microphone handle grip structure in accordance with claim 3, wherein the pattern is a wooden vein pattern.

7. The microphone handle grip structure in accordance with claim 1, wherein the grip is made of natural leather or artificial leather.

8. The microphone handle grip structure in accordance with claim 1, wherein the handle is made of metal.
